(19) United States
(12) Patent Application Publication
(10) Pub. No.: US 2023/0186415 A1
(43) Pub. Date: Jun. 15, 2023

(54) CLIENT INTAKE INFORMATION CAPTURE SYSTEM AND METHODS

(71) Applicant: Simple Will, LLC, Little Rock, AR (US)

(72) Inventors: Patrick Murphy, Little Rock, AR (US); John Starling, Little Rock, AR (US)

(73) Assignee: Simple Will, LLC, Little Rock, AR (US)

(21) Appl. No.: 18/078,367

(22) Filed: Dec. 9, 2022

Related U.S. Application Data
(60) Provisional application No. 63/287,704, filed on Dec. 9, 2021.

(51) Int. Cl. G06Q 50/18; G06Q 30/0601; G06F 40/174

(52) U.S. Cl. CPC G06Q 50/18; G06F 40/174; G06Q 30/0627

(57) ABSTRACT

A system and methods for streamlining the legal client intake process and revolutionizing the way legal representation in general is effectuated is disclosed. The system includes an intake platform, and optionally includes one or more of the following modules which interface with the intake platform: a scheduling module, a messaging client, a documents database, a virtual meeting platform, a client database, an attorney database, a payment module. The system is capable of formalizing an engagement for legal services between the user and a practitioner selected by the user, generating drafts of legal documents, sending drafts of such legal documents to the user and practitioner, scheduling an initial meeting between the user and practitioner, and soliciting and accepting payment for legal services, via a single platform.

### CROSS-REFERENCE TO RELATED APPLICATIONS

This nonprovisional application claims the benefit of priority under 35 USC §119 to U.S. Patent Application No. 63/287,704, filed on Dec. 9, 2021, the entirety of which is incorporated herein by reference.

### BACKGROUND OF THE INVENTION

### Field of the Invention

The invention relates primarily to a system and methods for streamlining legal client intake. More specifically, the present invention is a novel intake platform which enables on-demand formation of a legal engagement between a practitioner and prospective client, in combination with document generation, messaging, scheduling, and payment.

### Description of the Background

Many people use legal services for a wide variety of personal and business needs. Traditionally, an individual or business with a legal need will rely on Internet searches, referrals from family/friends, or other word-of-mouth means to locate a lawyer who may or may have the best expertise, or be the best overall fit, for the specific need facing the prospective client. Complicating this process is that the advice needed by many prospective clients varies based on the law of a specific state, and thus an attorney who has expertise regarding specific state laws (and/or is licensed to practice in a state, or local/regional court system) is required on a case-by-case basis. Individuals and entities alike often need to undertake a considerable amount of research and “shopping around” to locate an attorney who has the required expertise for a given legal issue, and who can meet the prospective client’s target budget for legal services.

Likewise, attorneys typically exert considerable time and resources towards attracting clients or prospective clients who have legal needs that match that given attorney’s expertise. Those efforts could include online or other digital marketing, print advertising, and/or attending in-person networking events. Attracting clients with relevant needs is especially difficult for small firms or solo practitioners who may have relatively small marketing budgets or limited name recognition in a relevant geographic area or subject matter, or for attorneys with niche skill sets for whom the prospective client base is more limited.

Once a prospective attorney-client match is made, there are many administrative hurdles to overcome before the attorney can even begin the work designed to result in a written deliverable (such as a last will and testament or written contractual agreement) being provided to the client by the attorney. Administrative burdens fall on both the prospective client and the chosen attorney. Typically, an attorney will need to collect several critical pieces of information from the client/prospective client, any of which could cause a communication error at best, and a potential malpractice claim at worst, if entered erroneously. Information collected from the client may include identifying information pertaining to the client personally, identifying information about other parties implicated in a given transaction or legal arrangement (such as heirs in a last will and testament, or authorized parties in an advanced medical directive), information about the prospective client’s employer, information about the geographic location where the prospective client’s legal needs arise or will arise, or the like. The administrative burden of collecting this information falls on the client to collect and provide the requested information, and on the attorney to accurately record it, sometimes needing to compile it from multiple oral conversations and/or disjointed email correspondence spread across several days or weeks. Typically, the client will access information pertinent to the engagement from various unrelated locations and mediums such as print via a file cabinet or digital via a computer file, flash drive or elsewhere. Moreover, the attorney bears the initial administrative burden of ensuring that he or she is requesting each type or category of information that he/she is required to collect from the client at the outset of the engagement, which will have nearly infinite variability based on the nature and scope of the project for which the attorney is being retained, and which can also change in real time based on information received from the client.

The attorney/client engagement process also necessarily entails, under the ethics laws applicable to attorneys in most jurisdictions, formalizing the attorney/client relationship in writing, and otherwise confirming to the prospective client that the chosen attorney is now engaged to provide legal services and represent that specific client’s interest. Traditionally, this involves burdens that also fall on both the attorney and the prospective client, in that a written engagement letter is usually drafted by the attorney or his/her assistant, provided in hard copy and/or via email to the prospective client, printed and reviewed by the prospective client, and then signed and scanned back to the attorney by the new client. Many of these steps require that the prospective client have access to equipment (printers, scanners, etc.) or software (electronic signature software, PDF viewing software, etc.) that the prospective client may not have readily available. Breakdowns in this portion of the engagement process may cause stress or anxiety on the part of the prospective client, who may need to wait for confirmation that he/she has retained an adviser for a pressing, time sensitive legal need, and could also cause potential malpractice issues for the attorney, in that state ethics laws require certain behavior on the part of the attorney before an engagement is formalized, and somewhat different behavior after the engagement is formalized - thus the attorney who does not know a date/time certain that the engagement has been formalized runs the risk of contravening those ethics laws.

Another engagement bottleneck that commonly plagues small and large law firms and solo practitioners alike is scheduling coordination between the attorney and prospective client. A prospective client is typically required to wait a period of time between making the initial connection with a prospective attorney and scheduling a meeting or phone call with that attorney, which could cause considerable stress to the client and in some instances make legal representation virtually impossible in scenarios where time is of the essence. Prior art online legal service operators commonly require prospective clients to pay a fee to the operator in advance, before the prospective client has the ability to ensure that the prospective attorney can meet with or speak with the prospective client within the client’s desired timeframe and/or on the client’s schedule. Additionally, prior art does not permit the real time creation of a formalized attorney client engagement between an attorney and the prospective client via a software platform. Rather, prior art systems and methods, such as LegalZoom, permit a prospective client to pay a fee to a non-attorney operator in exchange for the possibility of obtaining an attorney match on a limited, pro bono basis to discuss general legal matters, but no guarantee of an engagement or creation of an attorney client relationship between the “matched” attorney and the user.

Yet another administrative headache for both prospective attorney and prospective client is budgeting, billing and payment for legal services. On the client side, the client desires to understand at the outset the cost or potential cost of legal services, and the scope of those services. An individual or savvy business may wish to shop around for services based at least in part on cost, and traditional means of engaging an attorney make it nearly impossible to collect accurate cost estimates from various providers without inefficiently reaching out to each individual potential attorney and (after waiting for a call back) having a phone or in-person conversation and consultation with each such provider. The client also wishes to have an easy means to pay the attorney, such as by credit card, a form of payment which many law firms do not accept, and which many solo practitioners cannot afford to accept. Prospective clients who are businesses are often put off by the need to wait for an invoice for legal services, which could appear more than a month after the services are rendered, and which may complicate that businesses’ internal accounting procedures. Even modern law firms often find the need to spend large sums of money for legal budgeting/accounting software which performs these functions. On the attorney side, the attorney needs to be paid for his/her time and services, and preferably in an amount which can provide a profitable business model for that attorney, in a timely fashion. Larger law firms typically employ one or more individuals whose function is to pursue and collect delinquent client accounts. Small law firms and solo practitioners may not be able to afford to employ such a person, and may lose track of, or the ability to collect on, fees which are rightfully due to them based on services provided. Needless to say, collection of fees, legal or otherwise, is an important tenet to any business.

Another inefficient aspect of the attorney client relationship, from the attorney perspective, is often the re-creation of commonly-used documents ad nauseam from scratch for individual clients. Not only does this make an individual attorney less efficient, but, for nuanced legal documents, it could also mean that the attorney misses one or more important details that would typically be present in such an agreement. Of course, this can be a major problem for both attorney and client.

Prior art methods have attempted to resolve various individual aspects of the above-noted problems, but there is no prior art system or method which resolves all of the above potential bottlenecks, inefficiencies or trouble spots. For example, Legal Zoom provides one prior art method of client intake, whereby individual prospective clients are matched automatically with a lawyer based on specified criteria entered by the attorney and the client, not necessarily one that is chosen by the client after review of multiple possible attorney matches and attorney profiles. Moreover, Legal Zoom does not have a comprehensive platform to address the other attorney-client engagement, scheduling, document drafting and payment inefficiencies identified above.

What is needed, then, is a system and methods which streamline all of the above processes for the benefit of both attorney and prospective client.

### SUMMARY OF THE INVENTION

Embodiments of the present invention include systems and methods for streamlining the legal client intake process, and revolutionizing the way legal representation in general is effectuated, is disclosed. The system includes an intake platform, and optionally includes one or more of the following modules which interface with the intake platform: a scheduling module, a messaging client, a documents database, a virtual meeting platform, a client database, an attorney database, and a payment module. The system is capable of formalizing an engagement for legal services in real time between the user and a legal practitioner selected by the user, generating drafts of legal documents, sending drafts of such legal documents to the user and practitioner, real time scheduling an initial meeting between the user and practitioner, and soliciting and accepting immediate payment for legal services, via a single platform.

In particular, in embodiments, the present invention includes a method of creating, matching and/or tracking employee eligibility files, which enable a customer in the market for legal services to create an engagement with a desired attorney that is funded via payroll deduction or other employment benefit offered by that consumer’s employer, without requiring the employer to be involved in the (confidential) attorney / client (employee) engagement.

The foregoing objects, features and attendant benefits of this invention will, in part, be pointed out with particularity and will become more readily appreciated as the same become better understood by reference to the following detailed description of a preferred embodiment and certain modifications thereof when taken in conjunction with the accompanying drawings. Unlike prior art which attempts to disconnect the human element from technology (presumably due to costs constraints), the overarching purpose of the invention is to combine the synergies between the system and the trained legal practitioner to bring highly relevant, professional legal representation to the general public at affordable pricing.

### BRIEF DESCRIPTION OF THE DRAWINGS

In the drawings:

FIG. 1 is a high-level schematic of the inventive system according to embodiments of the present invention.

### DETAILED DESCRIPTION OF THE PREFERRED EMBODIMENTS

The present invention is a system and methods for streamlining the attorney-client intake process and revolutionizes the way legal representation in general is effectuated which resolves the headaches identified above with respect to prior art means of locating, engaging, paying, and doing intake on prospective clients, including those of online legal service providers, and further enables a given employer to offer a legal service (provided by licensed lawyers) as an employee benefit to its employees without needing to become involved in the legal engagement itself, nor in the selection or payment of the lawyer(s) in question. The present invention incudes a single online platform that a prospective client can use to (1) obtain accurate, up to date costs for one or more types of legal services, (2) select an attorney from a list of qualified practitioners based on criteria relevant to the prospective client, (3) upload all relevant details pertaining to a potential engagement for viewing by his/her selected attorney, (4) receive confirmation of engagement with the chosen attorney, (5) immediately schedule an initial meeting with the chosen attorney that works for both the client and attorney’s mutual schedules, and (6) pay for legal services, and in some embodiments, pay for such legal services via payroll deduction. In addition, the inventive solution includes means for immediately and automatically generating drafts of various types of legal documents based on the legal issue and/or engagement type selected by the prospective client, and immediately delivering them to both attorney and client, which provides a basis for the discussion between the attorney and client at an initial or subsequent attorney/client meeting. As used herein, the terms “on-demand loan”, “payroll deduction”, or “payroll deducted product” will be understood to refer to a loan of financial assets which is secured by the salary of an employee (potential client), and repaid through payroll deduction from that employee’s salary. However, in embodiments, it will be understood that a portion of the repayment of such loan could be offset by an employer contribution, for example, as a benefit of such employee’s employment.

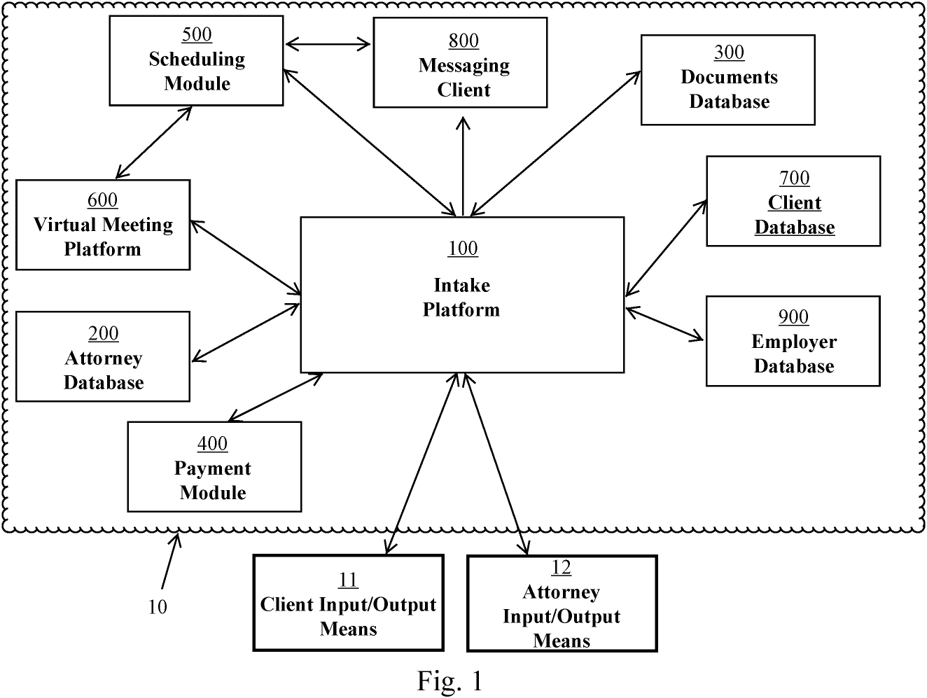

FIG. 1 is a high-level schematic of the inventive system according to embodiments of the present invention. As shown therein, the system 10 comprises an intake platform 100, which includes either downloadable or cloud-based processing means capable of running software for performance of various methods as described in more detail herein. The system 10 interfaces with client input/output means 11 and attorney input/output means 12 via intake platform 100. Input/output means 11, 12 may be desktop or mobile computing devices with means for inputting text, images, payment information, electronic signatures and indicating custom selections, connecting to virtual meeting platforms, and optionally uploading documents, such as a desktop computer, mobile phone, tablet, or the like. In embodiments, attorney input/output means 12 and client input/output means 11 are different devices as shown in FIG. 1.

In embodiments, intake platform 100 further includes means for interfacing with other software modules and/or databases as noted in FIG. 1, including one or more of the following modules, described in greater detail below: attorney database 200, documents database 300, payment module 400, scheduling module 500, virtual meeting platform 600, client database 700, messaging client 800, employer database 900, and/or benefit management system (not shown in FIG. 1). Although not shown in FIG. 1, it will be understood that, in some embodiments, input/output means 11, 12 may interface directly with the one or more modules 400, 500, 600, 700, 800, 900 instead of strictly interfacing with these modules via intake platform 100. In some embodiments, intake platform 100 may re-direct a user to one or more of modules 400, 500, 600, 700, 800, 900 via click-through link or the like, following which input/output means 11, 12 can interface with such modules directly.

In embodiments, intake platform includes means for generating a graphical user interface (GUI) visible on input/output means 11, 12 which will serve as one means for enabling the methods of the present invention. In embodiments, intake platform 100 includes means for generating different GUIs and corresponding prompts depending on the nature of the query received from input/output means 11, 12. For example, a GUI including a first series of prompts will be generated when the system 10 receives a login request for an attorney user, a GUI including a second series of prompts will be generated when the system 10 receives a login request for a prospective client user, a GUI including a third series of prompts will be generated when the system 10 receives a login request for an existing client user, and a GUI including a fourth series of prompts will be generated when the system 10 receives a login request for an administrative user. In other embodiments, the system 10 may generate distinct GUI’s including specific prompts tailored to login requests from different categories of attorneys, clients, prospective clients, and administrative users.

In embodiments, intake platform 100 also includes means to accept user inputs which are provided by the user via input/output means 11, 12. Further, based on various inputs received by one or more users, intake platform 100 includes means to send queries to one or more databases, such as attorney database 200, documents database 300, client database 700, and employer database 900, and to receive data in response to such queries for processing and/or display to the user via a GUI.

In embodiments, intake platform 100 also interfaces with messaging client 800, and comprises means to send an electronic message via email, text message, or other known means to one or more users.

Additional modules resident in system 10 will be described in greater detail below.

The present invention includes methods for streamlining the legal client intake process which are facilitated via the disclosed system 10. In some embodiments, the attorney-client intake process may be coordinated with the delivery of employee benefits from an employer to employee. In other embodiments, the attorney-client intake process is used to deliver an independent stand-alone product for an attorney or law firm that is mutually exclusive of any employee benefit program. In certain embodiments, attorney database 200 and documents database 300 may be databases which are populated or managed by an individual, or by an individual or group of authorized parties on behalf of a law firm or other organization. In other embodiments, attorney database 200 and documents database 300 may be populated or managed by an individual or group of authorized parties on behalf of a group of independent individuals or institutions.

One embodiment of the present invention includes a method whereby system 10 interfaces with client input/output means 11 to provide client-side assistance during the intake process according to one embodiment of the invention. The inventive method according to the present embodiment may include the following steps: (1) intake platform 100 receives an initial query, via client input/output means 11, from a prospective client who wishes to obtain legal services from an attorney; and (2) intake platform 100 generates a GUI which provides input fields prompting the user to enter preliminary intake information, and sends a command to client input/output means 11 to have the preliminary intake GUI displayed on that device. Preliminary intake information can include firm name, attorney name, city, state, or zip code, or area of attorney expertise. In some embodiments, at step 2, intake platform 100 generates a GUI requesting login information or a request to create an account, and sends a command to client input/output means 11 to have the login/create account GUI displayed on that device. Steps 1 and 2 can be performed in the order herein described, or in reverse order.

In some embodiments, intake platform 100 and/or payment module 400 may interface with the online platform(s) of one or more benefit programs, such as employee benefit programs, health care insurance plans, or other types of programs and plans that an employer can offer an employee and/or the HR system of an employer that administers such plan(s) and program(s); or with the online platform(s) of one or more vendors which administer such programs. In embodiments, payment module 400 may provide means to prompt an automatic payroll deduction from a salary electronically deposited to the prospective client’s bank account by his/her employer, instead of or in addition to accepting payment by credit card, as described in greater detail below. In some preferred embodiments, payment module 400 provides a means to provide an on-demand loan to a potential client / employee, which may be secured through (A) that client / employee’s salary, or (B) as a benefit of employment offered to client / employee by his employer or (C) a combination of (A) and (B). In one exemplary such embodiment, at least a portion of the GUI generated by intake platform 100 enables the collection of information from the potential client for use in generating an on-demand loan as described above, by linking to the online platform of a vendor that provides such a service. Optionally, intake platform 100 collects some or all of the information needed for such a loan from the client in advance of redirecting the client to the vendor’s online platform, and may provide such information to the vendor’s online platform, in order to create a seamless experience for the potential client. In preferred embodiments, the online platform for an on-demand loan vendor will enable the potential client to sign loan documents and fully consummate the chosen loan all within the online platform, such that funds can thereafter be immediately provided to the potential client for use in connection with services offered via intake platform 100.

In inventive methods involving the use of an employer benefit program, or on-demand loan, as a means of enabling the payments described hereunder, the method in preferred embodiments also comprises creation, by the intake platform, of an employee eligibility file including one or more pieces of identifying information pertaining to a prospective client, and storing said employee eligibility file in a database, such as client database 700, such that it can be logically associated with the prospective client to enable intake platform 100 to determine whether the given prospective client has satisfied a payment obligation, and perform additional steps based on such determination. In an alternative embodiment, the inventive intake platform 100 instead accesses a previously-created employee eligibility file and logically associates (cross-references) it with a prospective client / employee as described in more detail herein. In embodiments, an employee eligibility file as described herein is used by the inventive platform to confirm that a prospective client is in fact an employee of the employer that he/she has listed in submissions to intake platform 100, and/or is eligible for one or more discounts or benefits programs offered by his/her employer.

In inventive methods according to these embodiments, intake platform 100 may then receive further input from a potential client including identifying information (such as potential client name, a unique identifier generated by intake platform 100 during the initial contact/intake process with the potential client) which intake platform 100 can then use to associate the potential client with his/her employee eligibility file. Thus, in embodiments where a third party vendor payment/loan platform is utilized, intake platform 100 can confirm and verify that a given potential client has submitted payment and/or received a loan through such third party / vendor and enable the potential client to use the inventive system to engage an attorney and/or use funds obtained through a third party on-demand loan vendor to submit such funds via intake platform during a “checkout” process, to pay. Upon any/each of these events, intake platform 100 will collect data associated with the given transaction and logically associate that with the potential client file, and/or employee eligibility file, for tracking and population of data associated with the potential client or attorney/client relationship. In practice, in such embodiments, intake platform 100 creates an employee eligibility file, which contains data advising the system that the employee is eligible to receive payroll- or employment-secured benefits from a given employer, and upon submission, by the potential client, of one or more requests to the intake platform for data and/or legal services, intake platform 100 logically associates said employee eligibility file with said potential client/employee and his/her employer, which employer may have an entry in employer database 900, as described in greater detail below.

In embodiments, described in greater detail below, intake platform may interface with employer database 900, which may be an HR database provided by one or more employers, to allow auto-population of relevant employee data into the one or more fillable forms presented by intake platform, such as auto-population of dependent information for the generation of a last will and testament document for a prospective client or the inverse could occur such that the intake platform may interface with employer database 900 to allow auto-population of relevant employee data into an HR database provided by one or more employers, as will be described.

Following step 1, at step 3, intake platform 100 receives one or more data inputs from client input/output means 11 and, at step 4, sends a query to attorney database 200, including the data input received at step 3.

Attorney database 200 is preferably an electronic database which is populated with individual records, each record related to a single individual attorney who has registered with the system 10 as will be described. In embodiments, individual attorney records include one or more entries in one or more of the following data categories: attorney name, firm name, attorney address, firm address, attorney gender, attorney image, attorney bio, attorney legal specialties or practice areas, years licensed, jurisdiction(s) in which license(s) are held, firm legal specialties or practice areas, attorney email address, firm email address, firm website, attorney phone number, firm phone number, attorney fax number, firm fax number, attorney ratings, firm ratings, attorney signature (image), copies of licensing and/or insurance policies or agreements pertaining to the system 10 and/or to an affiliated employer’s benefits plan, as will be described, intake interview customization templates, details of participation in an employee benefit plan, and/or pricing information. In embodiments, each data category is tagged with one or more keywords such that a search query from intake platform 100 including one or more of said keywords as search terms will return a result with one or more pieces of profile information for one or more individual attorneys whose records include data matching said keyword(s). One or more pieces of profile information which may be returned as a result from such a query may include attorney name, firm name, attorney address, firm address, firm website, attorney website, attorney gender, attorney image, attorney bio, attorney legal specialties and/or practice area(s), firm legal specialties and/or practice area(s), attorney email address, firm email address, attorney phone number, firm phone number, attorney fax number, and/or firm fax number.

Accordingly, in embodiments of the present invention, at step 5, the intake platform 100′s query at step 4 returns one or more pieces of attorney profile information pulled from individual attorney records in attorney database 200 whose records include data matching the one or more inputs received from client input/output device at step 3. At step 6, intake platform generates a GUI which includes the one or more pieces of profile information received from attorney database 200, and sends a command to client input/output means 11 to have the attorney(s) profile(s) displayed as a GUI on that device. In embodiments, the attorney profile(s) GUI may include an image of a map associated with each individual attorney, where that attorney’s office and/or firm location is displayed on the map and/or where that attorney’s office and/or firm location is within a radius of a certain zip code. In embodiments, such a map is displayed via an application program interface from third-party software. In some embodiments, following step 5, the intake platform 100 at step 5A queries other third party databases to retrieve ratings information pertaining to one or more specific attorneys whose profile information was retrieved in step 5, and in step 5B intake platform receives such ratings information. In this embodiment, ratings information received from such third party platforms (or housed within an attorney database 200) may be included in the GUI displayed to the client input/output means 11 at step 6. At step 7, intake platform 100 receives an input from client input/output means 11 which corresponds to the profile information for a client’s chosen attorney from among the attorney profile entries displayed at step 6. Following step 7, if a client record has not already been created, the process proceeds to step 1B as described above.

Following step 1B, at which intake platform 100 displays a login/account setup prompt, at step 1C intake platform 100 receives user credentialing information from client input/output means 11 and stores it in client database 700 by creating a client record corresponding to each individual client or prospective client at step 1D. Each such client record may have data entries pertaining to one or more of the following categories of information: username, password, client name, client address, client billing information, and all other categories of information which will be collected by the system 10 as will be described herein.

In optional embodiments, employer database 900 may be an electronic database which is populated with information provided by one or more employers. In some embodiments, as noted above, the system 10 may interface with the online platform(s) of one or more benefit programs, such as employee benefit programs or health care insurance plans, and/or the HR system of an employer that administers such program(s), as well as with the online platforms of vendors who administer such benefits programs, or offer on-demand loans. Thus, in embodiments, employer database 900 can include multiple employer records, each corresponding to a specific employer (entity) which will allow individual employees to use (i.e., pay for) the inventive system and method under their employee benefit package, health plan, and/or via an on-demand loan secured by their salary or otherwise as a condition of their employment. Such employers may populate their individual employer record with information regarding one or more specific employees (based on employees which qualify for the benefit, employees which have been pre-cleared or pre-screened for payment guarantee, or otherwise based on user preference) affiliated with such employer. During steps 1B, 1C and 1D, intake platform 100 may query employer database 900 to automatically populate a given user’s credentialing, payment, or other information or employee eligibility file from employer database 900 based on a code provided by a given user or like indicia (or data received by intake system 100 from a third party vendor such as a on-demand loan provider), and/or may affiliate the client record created for a specific user in client database 700 with a record created within the record of that user’s employer in employer database 900. In some embodiments, after correlating a given user with a given employer in employer database 900, intake platform 100 may also transmit data to employer database 900, including any data input by the given user during any of the inventive steps.

In some embodiments, at step 11, intake platform 100 generates an intake interview GUI, and sends a command to client input/output means 11 to display said GUI. Intake interview GUI may be customized by data drawn from the selected attorney’s intake interview customization template, associated with the selected attorney’s record in the attorney database 200, as will be described. Alternatively, intake interview GUI may be drawn from one or more preset intake interview forms stored in documents database 300, and include prompts to solicit input from the user regarding the type of legal services he/she desires to obtain from the selected attorney, based on the legal specialties indicated in the selected attorney’s profile. Thus, in embodiments, display of the intake interview GUI is preceded by step 8, querying attorney database 200 to determine whether the selected attorney has an intake interview customization template for display at step 9, and/or whether the attorney has indicated more than one specialty for display in a preset intake interview form, and step 9, receiving intake interview profile data from the selected attorney. If needed, intake platform 100 may then query documents database 300 to receive document/form information which may be requested by a specific attorney in his/her profile, as described below.

Alternatively, intake interview GUI can provide prompts to directly solicit information needed to populate one or more legal documents being requested by the client, in the case where a single legal service, such as estate planning document drafting, is being offered by a given attorney or by the system 10. Thus, in some embodiments, at step 8B, intake platform 100 queries documents database 300 to pull the requested document, which query returns, at step 8C, a form including input fields for the various information needed from the client to populate the requested document.

In embodiments, documents database 300 is a database including records for various legal documents that may be created in connection with the legal intake process. Preferably, each document record in documents database 300 has an associated record comprising a form with fillable fields for soliciting individual pieces of information needed to populate various fields of the given document, to customize the form for the client’s needs. Documents database 300 may also include custom forms with fillable fields that can be associated with and/or tagged to a specific attorney’s record in the attorney database. Documents housed in documents database 300 may also include engagement letters, and forms with fillable fields for same, as will be described herein. Documents housed in documents database 300 may also include the following documents and forms with fillable fields for same: last will and testament, personal property memorandum, durable power of attorney, healthcare power of attorney, living will, a living trust, a HIPAA release, and/or an asset/financial report. In embodiments, documents database 300 includes documents and forms with fillable fields for same that are organized by state according to the state law under which they are drafted, to which they pertain, and/or in which they are effective.

It will be understood that intake interview GUI may be multiple sequential GUI’s each directed to a specific category of information that the selected attorney or the system 10 has preprogrammed to solicit from the client in order to populate and/or customize the desired legal document(s) required for intake. The legal document(s) required for intake include at least an engagement letter between the client and the selected attorney, and may also include any number of other legal documents or agreements that the client may request, and the attorney has pre-programed the system to request information pertaining to, at the initial intake stage.

In embodiments, after intake platform 100 displays the intake interview GUI at step 10, at step 11 intake platform 100 receives inputs from the client input/output means 11 corresponding to fillable fields and/or drop down menus in the one or more GUIs comprising the intake interview GUI. Intake interview GUI(s) may update in real time based on information received from client input/output means 11, i.e. to show or hide various fields. The commands related to which fields are presented to the user based on received from client input/output means 11 is pre-programed in correlation to the given document being populated as it resides in documents database 300. Thus, steps 10 and 11 as shown in the FIGURE may repeat numerous times as the GUI is re-framed based on input received from client input/output means 11. As inputs are received from client input/output means 11, they are stored in client database in connection with the given client’s record.

In some embodiments, fillable fields (and/or drop down menus) in intake interview GUI may be automatically populated with information received from employer database 900, in the case where a specific user is affiliated with a specific employer who has created a record in employer database 900 and populated that record with information pertaining to that employee, whereby the user’s identity as the employee in question may be confirmed by the user providing a specific code or other piece of identifying information.

In embodiments, at least one of the inputs requested by intake platform 100 and received from client input/output means 11 is an electronic signature to be placed on an engagement letter between the given client and the chosen attorney. In this way, the inventive platform solves one major problem afflicting all known prior art solutions; the inability of prior art platforms to enable the generation of a legal engagement between a specific attorney and a potential client. In known prior art solutions, an attorney-client engagement is not enabled, because, for example, the prior art solution chooses an attorney from its roster of partners / independent contractors and arbitrarily matches the partner with the prospective client, or the prior art solution charges a fee for the opportunity to receive a list of potential attorneys that the prospective client can then engage with independently.

In embodiments, following steps 10 and 11, at step 12, intake platform may generate, and send a command to client input/output means 11 to display, a documents GUI showing completed copies of documents that intake platform 100 has generated using the input received from client input/output means 11 and one or more form template(s) from documents database 300. In preferred embodiments, the documents GUI includes at least a copy of an engagement letter signed by both the prospective client and the chosen attorney. To populate the engagement letter with the chosen attorney’s electronic signature, at step 12A intake platform may query attorney database 200 and at step 12B receive the image file of the chosen attorney’s signature from his/her respective profile. It will be understood that documents GUI may be one or more individual GUIs which the user may toggle back and forth through for review of the fields and inputted information.

In embodiments, data received from client input/output means 11 can be retrieved by the given client at any time if client accesses intake platform 100 and provides his/her credentialing/login information. Intake platform 100 may then send a query to client database 700 to (A) confirm the client’s credentialing/login information and (B) retrieve prior inputs received from client input/output means 11 and associated with that client’s profile. Intake platform 100 may provide a revised documents GUI which auto-populates information the client has already provided and prompts the client to enter information not yet received for the completion of a given document. In this way, the client can leave and return to the form at any time, if needed.

In embodiments, the system can transmit documents generated by the inventive system using the input received from client input/output means 11 and one or more form template(s) from documents database 300 for storage in both the client database 700 (affiliated with a specific client) and attorney database 200 (affiliated with the selected attorney and/or his/her law firm). In embodiments, intake platform 100 may enable retrieval of such documents by the affiliated attorney (as described above with reference to the client’s ability to actively edit such documents) for active editing (after the documents are generated) by the affiliated attorney.

In embodiments, before or after completion of steps 10 and 11, intake platform may interface with one or more of payment module 400, scheduling module 500 and/or messaging client 800. For example, intake platform 100 may generate a “checkout” GUI which enables the potential client to pay for the services requested, and intake platform 100 can further send a query to one or more of the databases described herein (such as client database 700) to obtain an employee eligibility file which will indicate to intake platform 100 that the potential client has obtained an on-demand loan (from an employer/employee benefit program or the like) which will be used to pay for the requested services, or that the potential client has otherwise secured funding or remitted payment. As described previously, in embodiments, an employee eligibility file as described herein is used by the inventive platform to confirm that a prospective client is in fact an employee of the employer that he/she has listed in submissions to intake platform 100, and/or is eligible for one or more discounts or benefits programs offered by his/her employer.

In some embodiments, payment module 400 may include a third-party payment portal which is accessed via intake platform 100 via an application programming interface (API). Intake platform 100 may generate, send a command to client input/output means 11 to display, a GUI which requests inputs required to process a payment in a pre-determined amount, as will be described, such as credit card information. Payment module may include means to transmit payment accepted from a user to the attorney selected for legal services by said user, including by automatic deposit into one or more bank accounts held by said attorney and/or his/her law firm.

In some embodiments, the inventive system is used by an individual user who has an employer who has extended use of (i.e., the cost of use of) the inventive system to all or a select number of its employees as an employee and/or health care benefit. Accordingly, in some embodiments, payment module 400 will enable payment via payroll deduction from the paycheck of the given user, as provided by his/her employer. Thus, in embodiments, the user may provide a code to intake platform (i.e., by inserting into a fillable field in one or more intake forms or registration forms in one or more GUIs generated by the system) to indicate that the user’s individual payment to the selected/hired attorney will be via payroll deduction. Such a code could be specific to a given employee/user, or to a specific employer, in which case queries to the client database 700 and/or employer database 900 by intake platform 100 may confirm the identity of the user in question and/or his/her eligibility for the benefit(s) in question. In embodiments, intake platform 100 may query employer database 900 to confirm that information input by the user in question matches information held in a given employer record. In embodiments, the system may run a separate credit-worthiness check and to update a user record in client database 700 with pass/fail information pertaining to such check. In some embodiments, a credit-worthiness check may be completed on the front end (that is, before any individual user accesses intake platform 100), such as when a given employer provides identifying information for its various employees to be uploaded to employer database 900 and/or client database 700. In embodiments, where the system 10 has confirmed that payment via payroll deduction has been authorized and/or that the potential client is eligible, instead of generating a GUI requesting credit card information from the user, intake platform 100 can generate a lender agreement and/or payroll deduction authorization form, and solicit a signature from the user indicating his/her agreement to be bound by such lender agreement. Additionally, intake platform 100 (and/or payment module 400 and/or messaging client 800) may send a command (e.g., via SMTP file, SFTP file, API communication, email, or other messaging means) to an employer and a payroll lender to confirm the payroll deduction arrangement. A SMTP/SFTP message to a payroll lender may also include identifying information for the potential client, including but not limited to first and last name, physical address, email address, phone number, and/or social security number. In embodiments, upon receiving a signature from a potential client for placement on a lender agreement, the system also sends a SMTP/SFTP message to the employer and/or payroll lender which includes one or more of the following pieces of information: selected attorney identifying information; selected attorney bank account information; platform bank account information; dynamic price of selected services; copies of the executed loan documents; copies of executed payroll deduction authorization form (if separate from a loan document); employer name; and payroll schedule of employee/client.

Relevant details for such arrangement and/or instructions for transmission of such data to the relevant payroll lender and/or employer may be stored in the given employer’s record within employer database 900. In addition, intake platform 100 may transmit employee identifying data, including cost of legal services obtained by the respective employee via intake platform 100, to the employer for processing such payroll deduction. In embodiments, payment module 400 may be linked with a health savings account (HSA) operated by a given employer and/or in the name of a given employee. Data pertaining to these account(s) may also be stored in employer database 900 and/or client database 700.

In embodiments, intake platform 100 may store loan document(s) and/or payroll deduction form(s) in a record associated with the given client, such as in client database 700. Intake platform 100 may also generate on-demand or periodic reports to attorneys in attorney database 200 pertaining to payments of clients who have retained a given attorney and elected to pay for that attorney’s services via a benefit program and loan agreement. In addition, intake platform 100 may also generate on-demand or periodic reports to one or more employers whose employees have elected to pay for attorney services via an employer benefit program via the inventive system. In connection with this feature of the present system, intake platform 100 may also include means to initiate transfer of funds to or from accounts associated with the system, an employer, one or more attorneys or law firms, and/or a given benefit program and/or health savings account, and to create and store records of such transfers. Intake platform 100 may also include means to receive payroll reports from one or more employers and to update reports based on same.

Messaging client 800 includes means to send external messages such as e-mail or text messages. In preferred embodiments, intake platform receives receipt of payment from payment module 400, queries client database 700 for the prospective client’s email address, and generates a command to messaging client 800 to send a copy of the one or more documents generated during the intake process to the client via email. In embodiments, intake platform 100 also queries attorney database 200 for the selected attorney’s email address, and generates a command to messaging client 800 to send a copy of the one or more documents generated during the intake process to the selected attorney via email.

Scheduling module 500 includes electronic means for scheduling an appointment with the chosen attorney and placing notification of such appointment on an electronic calendar maintained by said attorney, in real time. In embodiments, scheduling module 500 includes means to query the chosen attorney’s electronic calendar and return data indicating available and unavailable periods on said attorney’s electronic calendar, which can then be populated into a visual representation of one or more monthly or weekly calendars. In embodiments, scheduling module 500 includes a GUI which allows a user to select an open date and/or time period on a chosen attorney’s calendar, updated in real time, and send a “booking request” which will place notification of such chosen appointment date/time on said chosen attorney’s calendar. In embodiments, scheduling module 500 can also simultaneously place notification on the user’s calendar, as in by sending an e-mail to the user with a .ics file or the like allowing the user to upload the notification into his/her personal or professional calendar of choice. In embodiments, scheduling module 500 includes means to include a link to a virtual meeting platform embedded within the calendar notification placed on the user’s and/or attorney’s calendar(s).

In embodiments, scheduling module 500 includes a back-end interface for attorney input/output means 12 to alter an individual attorney’s calendar availability in real time. Enabling a specific attorney to indicate his/her real-time availability is another specific benefit of the inventive system and method(s), in that a user may immediately create an attorney-client relationship via intake platform 100 and, in addition to immediately receiving drafts of legal documents, receive instant access to legal advice from one or more attorneys who wish to provide such a service, all via a remote, online platform. In embodiment, an attorney’s current, real-time status as “available” or “unavailable” for immediate connection via video chat with a potential client may be displayed to the potential client at step 6, wherein one or more attorneys matching a user’s search terms are displayed to the user. A search term may include “available now”, for example.

In embodiments, intake platform 100 confirms payment of the given fee via payment module 400 (and/or by confirming user signature on a loan agreement) prior to sending commands to messaging client 800 or scheduling module 500.

In embodiments, intake platform 100 may interface directly with a virtual meeting platform 600. In embodiments, virtual meeting platform 600 may interface directly with scheduling module 500, such as via an API embedded within scheduling module 500. Virtual meeting platform 600 may be one or more virtual meeting platforms known in the art, which may comprise means for enabling audio and/or visual communications between parties.

In embodiments, scheduling module 500 and messaging client 800 interface with one another such that electronic messages (text, email, or the like) can be sent via messaging client 800 to the user to remind him/her of meetings scheduled via scheduling module. In embodiments, such messages can be sent to the user directly from scheduling module 500.

Embodiments of the present invention also include methods for streamlining attorney-side tasks in a client intake process. Attorney users may access the inventive intake platform 100 via attorney input/output means 12 by one or more of the methods described above with respect to user access to the platform 100, including by providing identifying/credentialing information to access his/her individual profile, which the intake platform will generate for said attorney user upon initial login and store in attorney database 200 along with identifying information pertaining to said attorney user and other information input into the intake platform 100 by said attorney user. As noted above, information that may be associated with a given attorney’s profile/record in attorney database 200 may include: attorney name, firm name, attorney address, firm address, attorney gender, attorney image, attorney bio, attorney legal specialties, firm legal specialties, attorney email address, firm email address, attorney phone number, firm phone number, attorney fax number, firm fax number, attorney ratings, firm ratings, attorney signature (image), copies of licensing and/or insurance policies or agreements pertaining to the system 10 and/or to an affiliated employer’s benefits plan, as will be described, intake interview customization templates, and/or pricing information. Additionally, attorney and/or law firms may link their professional calendars with scheduling module 500 during profile creation.

It is envisioned that attorney users and/or law firms will utilize the inventive system in one or more of at least two ways: (1) by direct access to the inventive platform 100, and creation of a profile for storage in the attorney database 200, for access by a potential user (e.g., in the case of a solo practitioner); (2) by licensing a separate instance of the inventive platform 100, which may be customized with that attorney’s or law firm’s branding or in a manner of their choosing, such that the software which executes the invention may reside on server space owned and/or rented by that attorney or law firm. In the latter case, individual modules which interface with intake platform 100 may be owned/licensed or otherwise proprietary to that attorney-side user, and/or resident on his/her/its systems. Further, an individual or entity attorney-side user may choose to receive direct payment for legal services via payment module 400, and/or may choose to receive payment via direct withdrawal from an employee’s salary as described in more detail above. Interaction between intake platform 100 and payment module 400 may be altered as described above to accommodate the individual attorney / law firm arrangement. The individual attorney and/or law firm profile in attorney database 200 may include pricing schedules to reflect the desired and/or agreed-upon pricing model on an attorney by attorney or firm by firm basis. In embodiments, intake platform 100 may include means for a prospective client user to input a promotional code to obtain specialized pricing and/or to implement the salary withdrawal pricing option. In some embodiments, payment received from a given user is designated in part for an attorney, for his/her legal services, and in part for the operator of the inventive platform. As such, the inventive platform (i.e., payment module 400) may include means to bifurcate a payment according to a payment/fee formula and remit the respective portions of the payment to attorney and platform host. In embodiments, payment module 400 may include means to remit payment to the administrator of the inventive platform which may hold funds in trust for a given/selected attorney or law firm.

In some embodiments of the present invention, payment module 400 enables the payment by a potential client of an attorney in a manner which satisfies the state or local attorney ethics laws or guidelines. In particular, some prior art attorney/client match platforms request that payment be made from the potential client to the platform/service, with the service’s fee being deducted from the total amount paid before being remitted to a matched attorney. However, the rules applicable to attorneys in some states require that funds not pass through any third party between attorney and client. Thus, embodiments of the present invention, as described herein, enable a potential client to secure an on-demand or payday loan from a third party vendor, which vendor may coordinate the withdraw of the funds from the potential client’s upcoming paycheck. Upon receiving a query from a potential client, intake platform 100 may collect some initial information from such client before providing a link to the online platform of the payday / on-demand lender. Then, when the potential client returns to intake platform and provides matching credentialing information, intake platform 100 may enable the potential client to submit payment directly to a chosen attorney via another third party vendor (such as LawPay or the like) and update the potential client’s file/profile with all of this information, such that payment can be verified and a legal engagement can be consummated (and legal services potentially rendered) via the inventive system 10.

Accordingly, the system according to the present invention includes means for performing, facilitating and/or enabling the following steps of a method for streamlining a client intake process and revolutionizes the way legal representation in general is effectuated within a single platform, concurrently and/or in immediate sequence:
(1) soliciting and receiving a query from a prospective client including various selection criteria for an attorney to meet one or more legal needs;
(2) populating a listing of practitioners based on selection criteria input by a user, optionally including pricing information pertaining to specific legal services and/or documents offered by each practitioner on an individual basis, or based on standard rates mandated by an administrative user of the system;
(3) optionally, generating a user profile for said user, whereby user identifying information, user credentialing information, and information input into the system is stored in a record associated with said user’s individual profile;
(4) generating one or more editable documents each including one or more fillable fields into which said user can input data, where said one or more documents are stored in a documents database;
(5) generating one or more document files pertaining to each of said one or more editable documents which include the information provided by the user, such as a custom last will and testament or health directive in Word or PDF format;
(6) formalizing an engagement for legal services between the user and a practitioner selected by the user by soliciting and receiving and/or entering time stamped electronic signatures on an electronic document containing terms of a legal engagement;
(7) soliciting and accepting payment for legal services from a user, and transmitting said payment to the selected practitioner;
(8) scheduling an appointment between the user and the chosen attorney based on real-time availability information pulled from the chosen attorney’s calendar;
(9) providing credentials for a virtual meeting between said user and the chosen attorney;
(10) sending an electronic message to the user including the one or more document files so generated, including an engagement letter; and
(11) sending an electronic message to the chosen attorney including the one or more document files so generated, including an engagement letter.

Embodiments of the present invention also include methods for providing client referrals to attorneys. Accordingly, the system according to the present invention includes means for performing, facilitating and/or enabling the following steps of a method for streamlining a client intake process and revolutionizes the way legal representation in general is effectuated within a single platform, concurrently and/or in immediate sequence:
(1) collecting information about an attorney’s or law firm’s identity, qualifications, and pricing module and storing same in a searchable database accessible via an online platform;
(2) attracting one or more prospective clients via engagement with an employer benefits program and/or the intake platform;
(3) presenting the attorney to a user based on his/her/a law firm’s match of user-input selection criteria;
(4) formalizing an engagement for legal services between the user and a practitioner selected by the user by soliciting and receiving and/or entering electronic signatures on an electronic document containing terms of a legal engagement;
(5) remitting payment for one or more legal services to the attorney and/or his/her law firm;
(6) sending an electronic message to the chosen attorney including the one or more document files so generated, including an engagement letter;
(7) scheduling an appointment between the user and the chosen attorney based on real-time availability information pulled from the chosen attorney’s calendar; and.
(8) providing credentials for a virtual meeting between said user and the chosen attorney.

We claim:

1. A method for capture of client intake information, the method comprising:
soliciting and receiving a query including one or more elements of selection criteria for a potential attorney;
populating a listing of one or more practitioners based on said one or more elements of selection criteria;
generating one or more electronically editable documents, each of said one or more electronically editable documents including one or more fillable fields;
receiving one or more elements intake data;
populating said one or more fillable fields with said one or more elements of intake data;
generating one or more document files pertaining to each of said one or more electronically editable documents and including said one or more elements of intake data;
generating a legal engagement document;
entering time stamped electronic signatures on said legal engagement document;
soliciting and accepting payment;
transmitting said payment to a bank account;
providing credentials for a virtual meeting;
sending an electronic message to one or more parties including said legal engagement document and said one or more document files.

2. The method of claim 1, wherein said one or more elements of selection criteria includes criteria selected from the list comprising pricing information, attorney name, firm name, attorney geographic location, firm geographic location, attorney specialty, firm specialty, attorney and/or firm practice area(s), and an attorney and/or firm’s participation in any employee benefit client referral program.

3. The method of claim 1, further comprising:
generating a user record; and
populating said user record with data selected from the list comprising identifying information, user credentialing information, and said one or more elements of intake data.

4. The method of claim 1, wherein said one or more document files is one or more documents selected from the list comprising a custom last will and testament, a healthcare power of attorney, a personal property memorandum, a durable power of attorney, a healthcare power of attorney, a living will, a living trust, a HIPAA release, and/or an asset/financial report.

5. The method of claim 1, wherein said step of generating one or more electronically editable documents includes a step of retrieving said one or more electronically editable documents from a documents database.

6. The method of claim 5, wherein said documents database is populated by an individual or a law firm.

7. The method of claim 1, wherein said step of providing credentials for a virtual meeting includes the sub-steps of:
receiving real-time availability of a selected one of said one or more practitioners;
presenting said real-time availability;
receiving a selection of a time window based on said real-time availability.

8. The method of claim 1, wherein said step of soliciting and accepting payment includes the sub-steps of:
generating a loan document selected from the list comprising a payroll deduction agreement or a loan agreement;
entering time stamped electronic signatures on said loan document to generate a signed loan document;
generating a mail file selected from a list comprising a SMTP file or a SFTP file; and transmitting said mail file to a lender.

9. The method of claim 8, wherein said step of transmitting said mail file to said lender further comprises:
transmitting said signed loan document to said lender; and
transmitting, to said lender, information selected from a group comprising identifying information for a selected one of said one or more practitioners, identifying information for a client, identifying information for said client’s employer, a payroll schedule for said client’s employer, pricing information, and bank account information.

10. The method of claim 8, further comprising the step of transmitting said mail file to a client’s employer.

11. The method of claim 10, wherein said step of transmitting said mail file to a client’s employer further comprises:
transmitting said signed loan document to said employer; and
transmitting, to said employer, information selected from a group comprising identifying information for a selected one of said one or more practitioners, identifying information for said client, identifying information for said client’s employer, a payroll schedule for said client’s employer, pricing information, and bank account information.

12. The method of claim 1, wherein said step of populating a listing of one or more practitioners based on said one or more elements of selection criteria comprises the sub-steps of:
sending a query comprising said one or more elements of selection criteria to an attorney database;
receiving said listing of one or more practitioners in response to said query.

13. The method of claim 1, wherein said step of soliciting and accepting payment comprises the sub-steps of:
sending a query comprising user identifying information to an employer database;
cross-checking said user identifying information with information held in said employer database; and
presenting pricing information based on the results of said cross-checking step.

14. The method of claim 1, wherein said step of soliciting and accepting payment comprises the sub-steps of:
providing a link to the online platform of a vendor offering on-demand loans;
generating a new employee eligibility file for a user, or cross-referencing an existing employee eligibility file for said user;
generating a GUI requesting identifying information from said user;
associating said new employee eligibility file or existing employee eligibility file with said user and an employer of said user; and
generating a GUI to solicit information needed to make payment directly to an attorney or law firm.

15. A system for capturing client intake information, the system comprising:
an intake platform;
a scheduling module operatively connected to said intake platform;
a messaging client operatively connected to said intake platform;
an attorney database operatively connected to said intake platform;
a client database operatively connected to said intake platform;
a documents database operatively connected to said intake platform; and
a payment module operatively connected to said intake platform.
